(19) United States
(12) Patent Application Publication
(10) Pub. No.: US 2011/0161592 A1
(43) Pub. Date: Jun. 30, 2011

(54) Dynamic system reconfiguration

(76) Inventors: Murugasamy K. Nachimuthu, Beaverton, OR (US); Mohan J. Kumar, Aloha, OR (US); Chung-Chi Wang, Sunnyvale, CA (US)

(21) Appl. No.: 12/655,586

(22) Filed: Dec. 31, 2009

(51) Int. Cl. G06F 12/08; G06F 12/00; G06F 1/24

(52) U.S. Cl. 711/125; 711/137; 711/135; 711/163; 713/100; 711/E12.001; 711/E12.02; 711/E12.022; 711/E12.057

(57) ABSTRACT

In some embodiments system reconfiguration code and data to be used to perform a dynamic hardware reconfiguration of a system including a plurality of processor cores is cached and any direct or indirect memory accesses during the dynamic hardware reconfiguration are prevented. One of the processor cores executes the cached system reconfiguration code and data in order to dynamically reconfigure the hardware. Other embodiments are described and claimed.

### TECHNICAL FIELD

The inventions generally relate to dynamic system reconfiguration.

### BACKGROUND

With the introduction of scalable Quick Path Interconnect (QPI) servers having the capability of building large multiprocessor (MP) systems (for example, with 128 sockets), the reconfiguration of systems becomes very complex. Memory controllers are being integrated into each processor socket. Additionally, other components (such as IO root complex, IO devices . . . ) could be integrated into one or more processor sockets in the future. This adds further complexity in the address routing. Reliability, Availability, and Serviceability (RAS) features such as, for example, processor hot plug and Input/Output Hub (IOH) hot plug, memory migration, CPU Migration . . . are added to the feature list. With this additional complexity and new features, implementing a dynamic system reconfiguration solution in the hardware is very complex and expensive to develop and validate.

RAS operations (especially the one that impact system configuration at runtime) are currently implemented using System Management Interrupt (SMI), where the SMI brings all the processors together, performs a quiesce of QPI agents (such as processors, IOHs, etc.), and reprograms the system configuration (such as QPI routes, address decoders, etc). However, despite the link nature of the QPI interconnect, the changes to all QPI agents (processors, IO Hub . . . ) have to be done atomically to prevent misrouted data traffic. This poses a special challenge when this reconfiguration is performed by SMI code which itself executes out of coherent memory, which cannot be tolerated during QPI route changes. Note further that SMI operation is transparent to the OS (Operating System) and hence it is required to keep SMI latency to a minimum (typically in the order of hundreds of microseconds) for reliable system operation.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

FIG. 2 illustrates a system according to some embodiments of the inventions.

FIG. 3 illustrates a system according to some embodiments of the inventions.

FIG. 4 illustrates a flow according to some embodiments of the inventions.

FIG. 5 illustrates a flow according to some embodiments of the inventions.

FIG. 6 illustrates a flow according to some embodiments of the inventions.

FIG. 7 illustrates a flow according to some embodiments of the inventions.

FIG. 8 illustrates a system according to some embodiments of the inventions.

FIG. 9 illustrates a system according to some embodiments of the inventions.

FIG. 10 illustrates a flow according to some embodiments of the inventions.

FIG. 11 illustrates a flow according to some embodiments of the inventions.

### DETAILED DESCRIPTION

Some embodiments of the inventions relate to dynamic system reconfiguration.

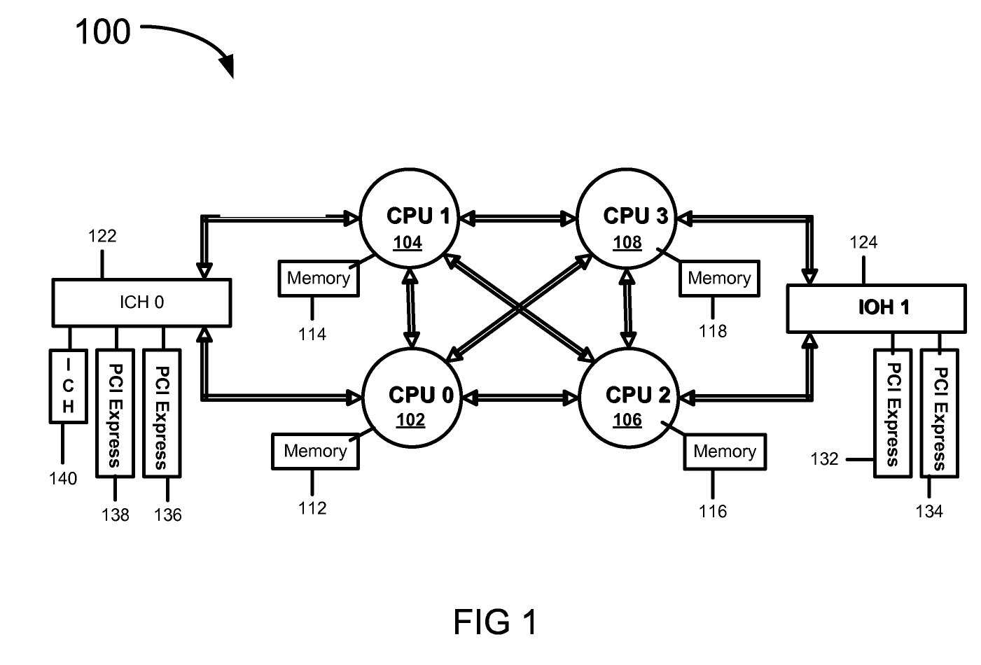

FIG. 1 illustrates a system 100 according to some embodiments. In some embodiments system 100 includes a plurality of processors and/or Central Processing Units (CPUs), including for example CPU0 102, CPU1 104, CPU2 106 and CPU3 108. In some embodiments system 100 additionally includes a plurality of memories, including for example, memory 112, memory 114, memory 116, and memory 118. In some embodiments, each of the processors 102, 104, 106, and 108 has a memory controller. In some embodiments system 100 additionally includes one or more Input/Output Hubs (IOHs), including for example IOH0 122 and IOH1 124. In some embodiments IOH1 124 is coupled to PCI Express bus 132 and/or PCI Express bus 134, and/or IOH0 122 is coupled to PCI Express bus 136, PCI Express bus 138, and/or Input/Output Controller Hub (ICH) 140. In some embodiments the processors 102, 104, 106 and 108 and the IOH 122 and IOH 124 are coupled together by a plurality of links and/or interconnects. In some embodiments, the links and/or interconnects coupling the processors 102, 104, 106 and 108 and the IOH0 122 and IOH1 124 are a plurality of coherent links, such as, for example, in some embodiments, Quick Path Interconnect (QPI) links and/or a plurality of Common System Interface (CSI) links.

In some embodiments, system 100 is a four socket QPI-based system. In some embodiments, QPI components (for example, processor sockets and/or I/O hubs) are connected using Intel QPI links and are controlled through Intel QPI ports. In some embodiments, communication between the QPI components is enabled using Source Address Decoders (SAD) and routers (RTA). A Source Address Decoder (SAD) decodes in-band address access to a specific node address. A QPI Router routes the traffic within the QPI components and to other QPI components.

According to some embodiments, QPI platforms require that all Source Address Decoders and Routers in the system are programmed identically to protect against the misrouting of traffic. During a boot operation, this programming may be accomplished in the Basic Input/Output System (BIOS) before any control is handed over to the operating system (OS).

In some embodiments, after the system is booted to the OS, Reliability, Availability and Serviceability (RAS) events can change the system configuration. For example, RAS events include operations such as processor add, processor remove, IOH add, IOH remove, memory add, memory move, memory migration, memory mirroring, memory sparing, processor hot plug, memory hot plug, hot plug socket, hot plug IOH (I/O hub), domain partitioning, etc. These and other types of RAS events require that QPI components be programmed dynamically while the OS continues to run. They require dynamically changing the system while the OS is running. Due to the requirement that the SAD and the routers be programmed identically at all times, these RAS operations require that any update to QPI configuration be done “atomically” (that is, no coherent traffic must be in progress while the QPI is reconfigured). Additionally, since the OS continues to run during such RAS events, the reconfiguration needs to be accomplished in a narrow time window (for example, typically on the order of hundreds of microseconds) in order to protect against OS timeouts.

High-end RAS features such as, for example, hot plug socket, hot plug processor, hot plug memory, hot plug I/O hub (IOH), hot plug of memory, hot plug of I/O chipset, hot plug of I/O Controller Hub (ICH), online/offline of processor, online/offline of memory, online/offline of I/O chipset, online/offline of I/O Controller Hub (ICH), memory migration, memory mirroring, processor (and/or CPU) migration, domain partitioning, etc. are key differentiators for high-end mission critical multiprocessor server platforms. Server and/or multiprocessor platforms based on a link such as QPI are designed to allow for high-end RAS features such as these, for example. As mentioned above, a common requirement to these RAS flows in QPI based systems is the need to atomically update QPI configuration (for example, QPI routing changes, Source Address Decoder changes, broadcast list, etc.) on all QPI agents (for example, on all processors and I/O Hubs).

In addition to being atomic, these changes need to be done in an OS transparent manner without impacting the running OS. According to some embodiments, a System Management Mode (SMM) is used to accomplish the routing changes using a System Management Interrupt (SMI). Traditional SMI code execution runs out of memory, which could be located on any QPI socket in the system. However, memory accessed during QPI configuration change results in potentially misrouted packets and compromises the integrity of the system unless memory access is prevented during the reconfiguration. Additionally, the SMI latency is limited to the order of hundreds of microseconds due to OS real time access expectations.

According to some embodiments, dynamic QPI system reconfiguration is performed in an atomic manner (that is, no coherent traffic like memory access occurs while reconfiguration is in progress), and meets Operating System/Virtual Memory Manager (OS/VMM) realtime response requirements.

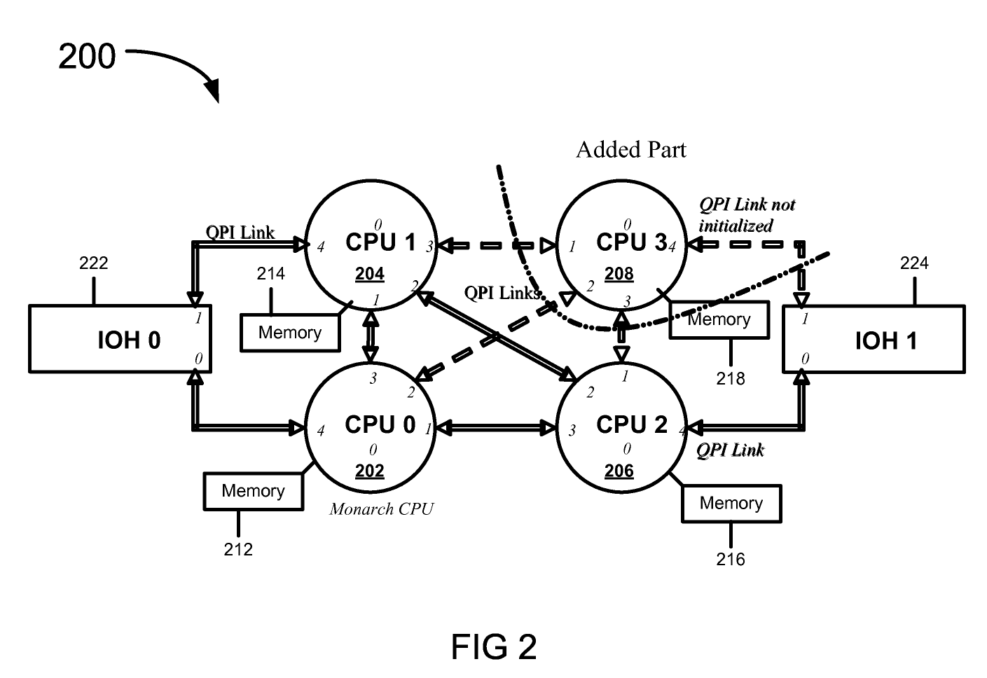

FIG. 2 illustrates a system 200 according to some embodiments. In some embodiments system 200 includes a plurality of processors and/or Central Processing Units (CPUs), including for example CPU0 202, CPU1 204, CPU2 206 and CPU3 208. In some embodiments system 200 additionally includes a plurality of memories, including for example, memory 212, memory 214, memory 216, and memory 218. In some embodiments, each of the processors 202, 204, 206, and 208 has a memory controller. In some embodiments system 200 additionally includes one or more Input/Output Hubs (IOHs), including for example IOH0 222 and IOH1 224. In some embodiments the processors 202, 204, 206 and 208 and the IOH 222 and IOH 224 are coupled together by a plurality of links and/or interconnects. In some embodiments, the links and/or interconnects coupling the processors 202, 204, 206 and 208 and the IOH0 222 and IOH1 224 are a plurality of coherent links, such as, for example, in some embodiments, Quick Path Interconnect (QPI) links and/or a plurality of Common System Interface (CSI) links.

The system 200 of FIG. 2 assumes that the CPU3 208 (and/or the CPU3 108 in the system of FIG. 1) was not present when the system was booted, and that CPU3 208 needs to be hot added to the running system. FIG. 2 illustrates port information for each of the QPI agents 202, 204, 206, 208, 222 and 224 in the system. The links (for example, QPI links) between the other processors 202, 204 and 206 and the IOHs 222 and 224 are shown as initialized and operating links, but the links between the CPU3 208 and the other components are shown in FIG. 2 using dotted lines since those links have not yet been initialized. In order to handle the hot add of CPU3 208, a discovery first needs to be made as to how the running system connects with the added CPU3 208. According to some embodiments, the router (RTA) and Source Address Decoders (SAD) on both the CPU3 208 and all the other QPI components 202, 204, 206, 222, and 224 need to be configured (or reconfigured) so that the CPU3 208 and memory 218 can be added to the running system.

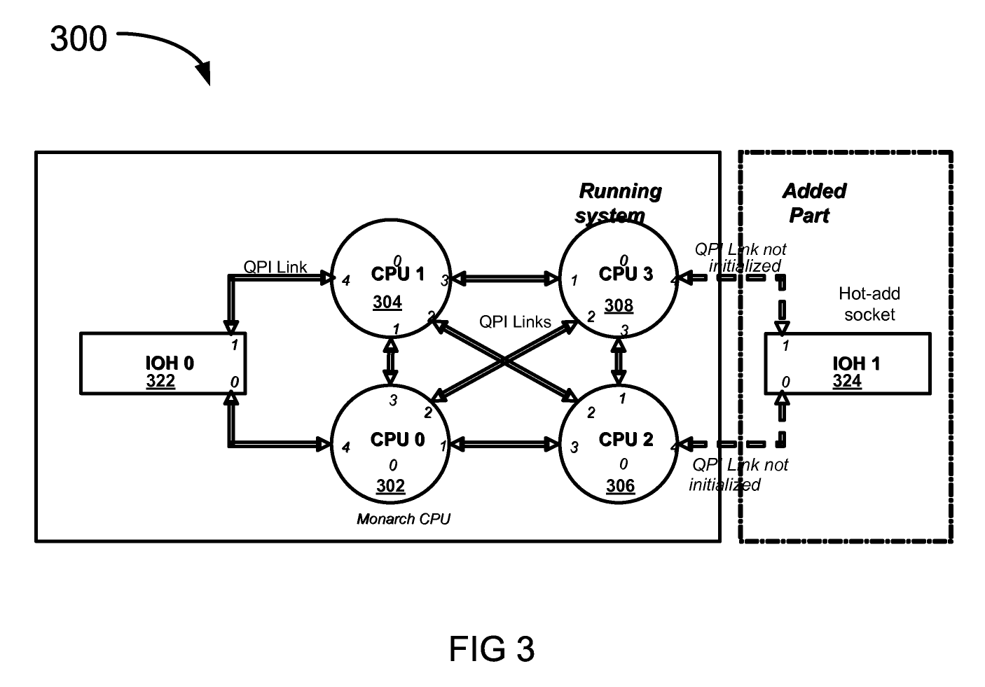

FIG. 3 illustrates a system 300 according to some embodiments. In some embodiments system 300 includes a plurality of processors and/or Central Processing Units (CPUs), including for example CPU0 302, CPU1 304, CPU2 306 and CPU3 308. In some embodiments system 300 additionally includes a plurality of memories, including for example, memory 312, memory 314, memory 316, and memory 318. In some embodiments, each of the processors 302, 304, 306, and 308 has a memory controller. In some embodiments system 300 additionally includes one or more Input/Output Hubs (IOHs), including for example IOH0 322 and IOH1 324. In some embodiments the processors 302, 304, 306 and 308 and the IOH 322 and IOH 324 are coupled together by a plurality of links and/or interconnects. In some embodiments, the links and/or interconnects coupling the processors 302, 304, 306 and 308 and the IOH0 322 and IOH1 324 are a plurality of coherent links, such as, for example, in some embodiments, Quick Path Interconnect (QPI) links and/or a plurality of Common System Interface (CSI) links.

The system 300 of FIG. 3 assumes that the IOH1 324 (and/or the IOH1 124 in the system of FIG. 1 and/or IOH1 224 in the system of FIG. 2) was not present when the system was booted, and that IOH1 324 needs to be hot added to the running system. FIG. 3 illustrates port information for each of the QPI agents 302, 304, 306, 308, 322 and 324 in the system. The links (for example, QPI links) between the processors 302, 304 306, and 308, and the other IOH0 322 are shown as initialized and operating links, but the links between the IOH1 324 and the other components are shown in FIG. 3 using dotted lines since those links have not yet been initialized. In order to handle the hot add of IOH1 324, a discovery first needs to be made as to how the running system connects with the added IOH1 324. The router (RTA) and Source Address Decoders (SAD) on both the IOH1 324 and all the other QPI components 302, 304, 306, 308, and 322 need to be configured (or reconfigured) so that the IOH1 324 can be added to the running system.

According to some embodiments, system reconfiguration code and data are cached, and any direct or indirect access to memory is prevented. In some embodiments, since the system reconfiguration is performed while executing out of a cache, any QPI link route or Source Address Decoder changes sill not affect the code execution.

According to some embodiments, only one processor core is allowed to run during the reconfiguration time windows, and all other cores are blocked from implementing any outbound accesses. In some embodiments, the reconfiguration data is computed outside a Quiesce—Unquiesce window to reduce SMI latency. According to some embodiments, dynamic reconfiguration of a QPI platform is accomplished using a runtime firmware flow using a QPI quiesce operation.

In some embodiments, Quiesce code is cached by reading the Quiesce code from memory. The Quiesce data is cached, and any modification of the data being written back into the memory is prevented by performing a data read and write operation to cause the cache line to be in a modified state. Prefetch is disabled to avoid memory accesses during the system reconfiguration code execution. Speculative loads from memory are not made by avoiding all address regions other than the Quiesce code and data. The uncore is flushed to make sure that all outstanding transactions are completed before performing any system reconfiguration operation. All other threads are synchronized in the system reconfiguration code executing in the core to make sure that they are executing out of the cache. All out of band (OOB) debug hooks are stopped during the system reconfiguration window.

According to some embodiments, QPI components support a Quiesce mode by which normal traffic is paused by all the QPI agents except the quiesce. According to some embodiments, a definition of a Quiesce Model Specific Register (MSR) of a processor is shown below. This register may be used according to some embodiments for software to initiate Quiesce, UnQuiesce, and UnCore Fence operations through the processor MSR.

| Bit | Default | |
|---|---|---|
| 2 | 0 | Uncore Fence. Flushes out all outstanding |
| | | uncore transactions issued by the core on which |
| | | the MSR wr [symbol] executed, as well as any cache |
| | | side effects of those transactions. |
| | | 1 - Uncore Fence |
| | | 0 - No change |
| 1 | 0 | UnQuiesce. Initiates the UnQuiesce operation of |
| | | the system. All the QPI agents listed in the |
| | | broadcast list allowed to resume operation. |
| | | 1 - Exit Quiesce state |
| | | 0 - No change |
| 0 | 0 | Quiesce. Initiates the Quiesce operation of the |
| | | system [symbol] the QPI agents listed in the |
| | | broadcast list enter the Quiesce state. |
| | | 1 - Enter Quiesce state |
| | | 0 - No change |

[symbol]

indicates data missing or illegible when filed

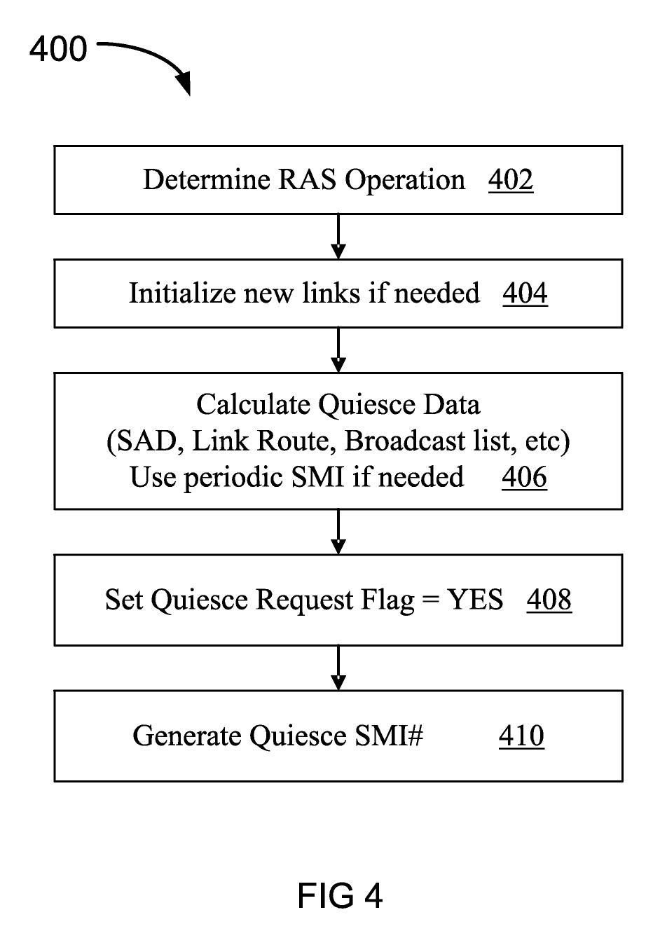

FIG. 4 illustrates a flow 400 according to some embodiments. In some embodiments, flow 400 is a Quiesce data generation flow. First, a RAS operation is determined and/or identified at 402. Then new links (for example, QPI links) are initialized at 404, if necessary. Then Quiesce data such as, for example, SAD, Link Route (and/or QPI Route), Broadcast list, etc. is calculated at 406 (for example, using a periodic SMI if needed). At 408 a Quiesce Request Flag is set. Then a Quiesce SMI# is generated at 410.

In some embodiments, only one processor core (for example, a “Monarch” processor) is allowed to run during the reconfiguration windows and all other cores are blocked from any outbound accesses. In some embodiments the reconfiguration data is computed outside the Quiesce-UnQuiesce window to reduce the SMI latency.

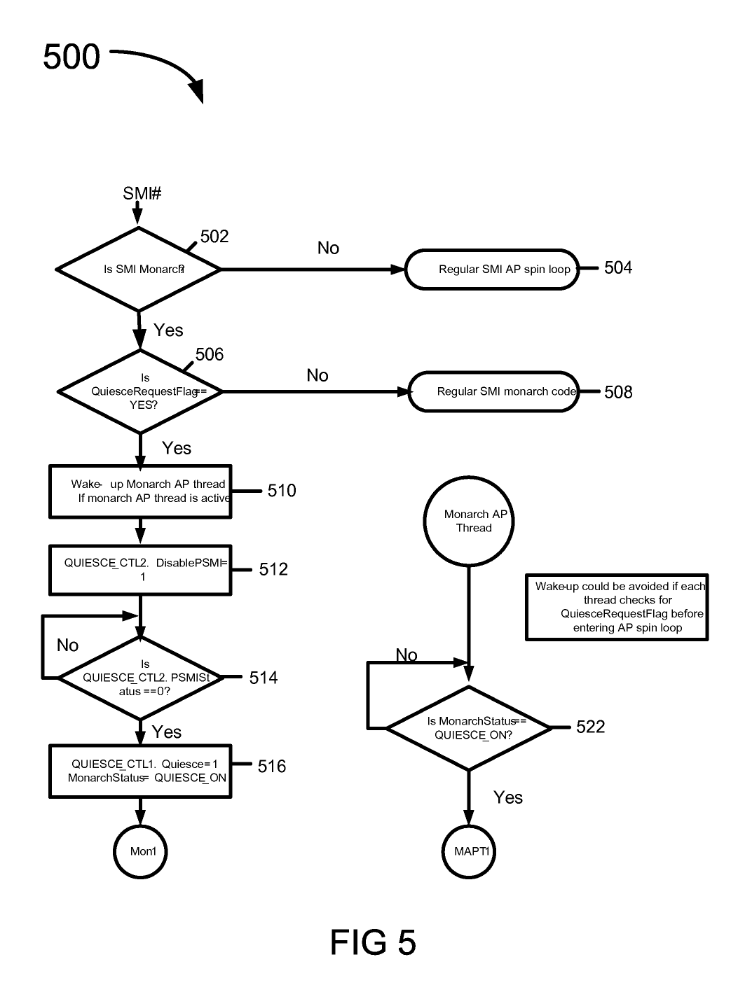

FIGS. 5, 6 and 7 illustrate flows 500, 600, and 700 according to some embodiments. In some embodiments, flows 500, 600, and 700 illustrates a flow to accomplish dynamic reconfiguration of a platform such as a QPI platform. In some embodiments, flows 500, 600, and 700 use a runtime firmware flow implementing a QPI quiesce.

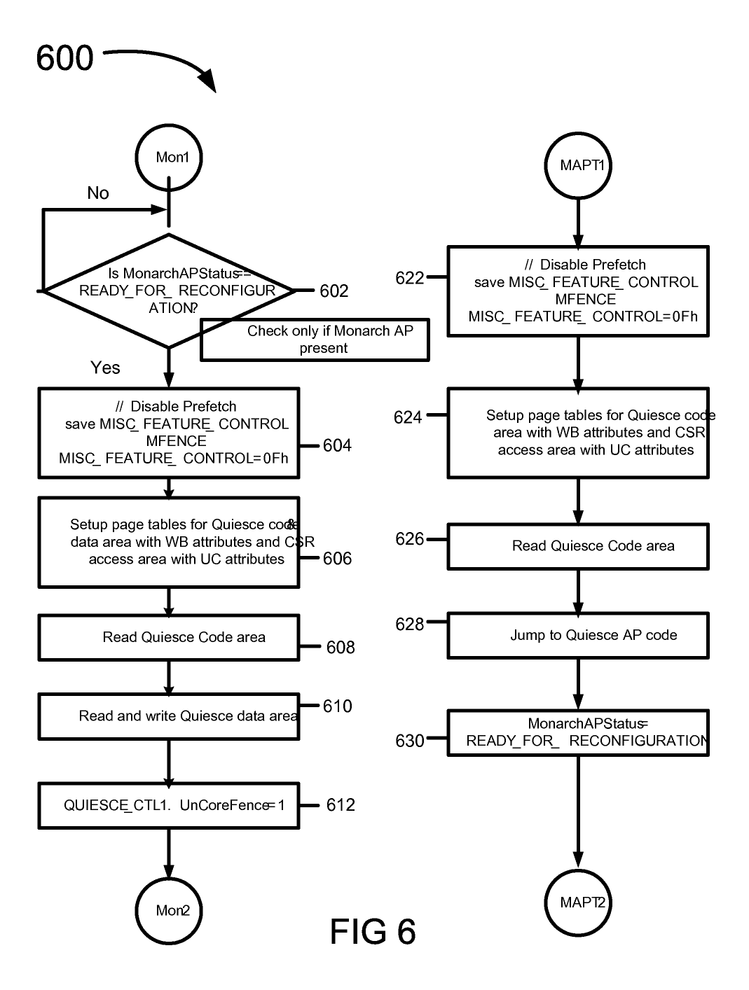

The Quiesce Monarch core is selected out of all the available cores in the system to carry out the Quiesce, system reconfiguration, and UnQuiesce operations. The Quiesce core might have multiple threads. Each of the Quiesce core threads need to make sure that it does not access any memory during the reconfiguration operation. This operation is outlined, for example, as a Monarch AP (Application Processor—i.e. non-monarch processor) thread in FIGS. 5, 6, and/or 7, for example.

At 502 of FIG. 5 a determination is made as to whether the SMI is running on the Monarch QPI agent (for example, a Monarch processor) identified as the one processor allowed to run during reconfiguration. If it is not an SMI Monarch at 502 then a regular SMI AP (Application Processor—i.e. non-monarch processor) spin loop is performed at 504. If it is an SMI Monarch at 502 then a determination is made at 506 as to whether a Quiesce Request Flag is set. If the Quiesce Request flag is not set at 506 then regular SMI Monarch code is performed at 508. However, if the Quiesce Request flag is set at 506 then a wake-up Monarch AP thread is implemented at 510 (for example, if the Monarch AP thread is active). In some embodiments, wake up could be avoided if each thread checks for the Quiesce Request Flag before entering the AP spin loop.

The Quiesce Monarch disables any outside agents' access to the memory or Configuration Spare Registers (CSR) at 512. The RTA and SAD are normally implemented as CSR so that access to the CSR during the reconfiguration phase might result in proving wrong contents. This is accomplished in some embodiments by configuring implementation specific MSR or by requesting out of band (OOB) devices such as, for example, a Baseband Management Controller (BMC), a System Service Processor (SSP), and/or a Management Engine (ME). The outside agents' access to memory or CSR at 512 can be implemented in some embodiments, for example, by disabling processor debug hooks or by disabling access through processor side-band interfaces. A determination is made at 514 as to whether the outside agents' CSR access has been disabled. If it has not been disabled at 514 then flow in that thread remains at 514 until it has been disabled. Once it has been determined that the outside agents' CSR access has been disabled at 514 the Quiesce operation is initiated at 516 by setting the Quiesce bit in the QUIESCE_CTL register (for example, by setting QUIESCE_CTL1.Quiesce=1), and in some embodiments setting MonarchStatus to “QUIESCE_ON”. This operation makes sure that all the QPI agents enter the Quiesce state and do not initiate any new transactions. In the Monarch AP thread flow remains at 522 until a determination is made that MonarchStatus has been set to “QUIESCE_ON”. Flow from 516 moves to “Mon1” in FIG. 6 and flow from 522 moves to “MAPT1” in FIG. 6.

Once the system is in the Quiesce state, as shown in the Monarch thread flow in FIG. 6, the Monarch thread caches both code and data and starts executing out of cache with no exterminal memory access. At 602 a determination is made as to whether MonarchAPStatus is “READY FOR RECONFIGURATION”. This is checked in some embodiments only if the Monarch AP is present. Once the Monarch AP Status is “READY FOR RECONFIGURATION” a disable prefetch operation occurs at 604. In some embodiments this is accomplished at 604 by saving a MISC_FEATURE_CONTROL, then performing an “MFENCE” (Memory Fence—for example, a serializing operation that guarantees that every load and store instruction that precedes in program order the MFENCE instruction is globally visible before any load or store instruction that follows the MFENCE instruction is globally visible) and/or then setting MISC_FEATURE_CONTROL to 0Fh. In some embodiments, this is accomplished at 604 by saving prefetch controls, MFENCE, and disabling prefetch. At 606 page tables for Quiesce code and data area are set up with WB (Write Back caching attribute) attributes and CSR access area with UC (Uncached caching attribute) attributes. The page tables are set up such that there are no speculative loads outside the Quiesce code area. The page tables are set up such that only the Quiesce code area is UC. This indirectly makes sure that the speculative loads are not performed outside the Quiesce code area. At 608 the Quiesce code area is read to cache the code. At 610 a read and write of the Quiesce data area is performed. In some embodiments (not illustrated in FIG. 6), a jump to cached code is then performed (for example, a jump to Quiesce Monarch Code). At this step the code is executed out of cache, not from memory. At 614 an UnCoreFence bit is set (for example, QUIESCE_CTL1.UnCoreFence=1).

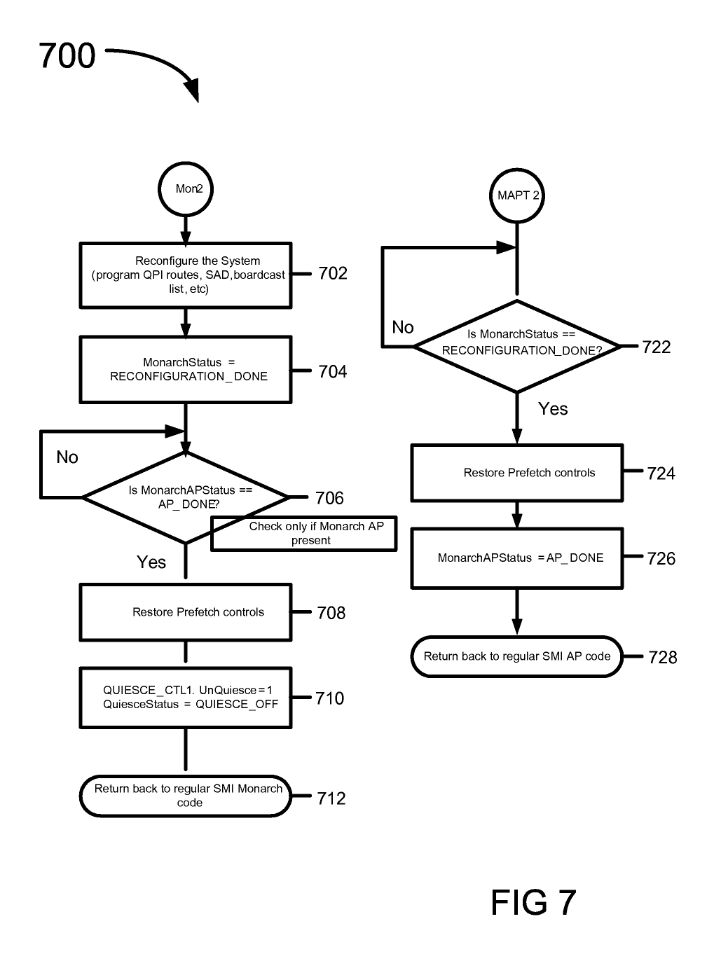

The Quiesce Monarch code is used in FIG. 6 to cache the Quiesce code and data. For example, a disable prefetch operation occurs at 622. In some embodiments, prefetch controls are saved, MFENCE, and prefetch is disabled. In some embodiments this is accomplished at 622 by saving a MISC_FEATURE_CONTROL, then performing an “MFENCE” (Memory Fence) and/or then setting MISC_FEATURE_CONTROL to 0Fh. At 624 page tables are set up for the Quiesce code area with WB attributes and CSR access area with UC attributes. The page tables are set up such that there are no speculative loads outside the Quiesce code and data area. The page tables are set up such that only the Quiesce code and data areas are UC. This indirectly ensures that speculative loads are not performed outside of the Quiesce code and data area. At 626 the Quiesce code area is read to cache the code. The Quiesce data area is read and written to in order to cache the data in the modified state. This makes sure that any Quiesce data accesses during the system reconfiguration do not cause memory access. At 628 a jump to the Quiesce Monarch code (and/or the Quiesce AP code) is implemented. At this step the code is executed out of cache. At 630 MonarchAPStatus is set to “READY FOR RECONFIGURATION”. Flow from 614 moves to “Mon2” in FIG. 7 and flow from 630 moves to “MAPT2” in FIG. 7. An UnCore fence is performed to make sure that all outstanding transactions, including cache victim traffic, from the cores, uncore, and sockets are drained. At this point all code and data accesses are from cache and no memory accesses are performed.

According to some embodiments the Monarch Quiesce is to reconfigure the system by programming RTA, SAD, etc. on each socket. The system is set to UnQuiesce and all cores can continue from previously paused locations. Prefetches and outside agents' CSR accesses are restored. This is accomplished, for example, according to FIG. 7. At 702 the system is reconfigured (for example, by programming QPI routes, SAD, Broadcast list, etc). At 704 Monarch Status is set to “RECONFIGURATION DONE”. A determination is made at 706 as to whether MonarchAPStatus is “AP_DONE”. In some embodiments, this is checked only if the Monarch AP is present. Once it is determined at 706 that the Monarch AP Status is “AP DONE” prefetch controls are restored at 708. At 710 the “QUIESCE_CTL1.UnQuiesce” bit is set to “1” and the “QuiesceStatus” is set to “QUIESCE_OFF”. Then a return back to regular SMI Monarch code is performed at 712.

At 722 a determination is made as to whether MonarchStatus is set to “RECONFIGURATION DONE”. Once it is, prefetch controls are restored at 724. At 726 MonarchAPStatus is set to “AP_DONE”. Then a return back to regular SMI AP code is performed at 728.

Systems with coherent links such as QPI, multiple processors (MP), multiple memory controllers, and multiple chipsets are being designed and becoming more and more common. Advanced RAS features including but not limited to processor hot plug, processor migration, memory hot plug, memory mirroring, memory migration, and memory sparing will become commonplace in the server market segments. RAS features demand a lot of work to be done by the Basic Input/Output System (BIOS) during runtime. According to some embodiments, system reconfiguration is implemented without requiring expensive hardware hooks.

Quick Path Interconnect (QPI) (and/or CSI) based server systems introduce advanced RAS features including but not limited to processor hot plug, memory hot plug, memory mirroring, memory migration, memory sparing, etc. These features require dynamically changing the system configuration while the operating system (OS) is running. These operations are currently implemented using System Management Interrupt (SMI), where the SMI brings all the processors together, performs a quiesce of API agents (such as processors, IOHs, etc.), and reprograms the system configuration (such as QPI routes, address decoders, etc). However, the SMI executes out of memory, which cannot be tolerated during QPI route changes. Therefore, in some embodiments, the SMI handler code and data is loaded into cache and executed out of it. This makes the runtime configuration flow very cache architecture dependent. Additionally, caching code and reprogramming QPI routes and address decoders by SMI code execution would take a considerable amount of time. Due to OS restriction on SMI latency, the SMI Quiesce and QPI programming code need to be written carefully with stringent timing constraints to meet latency requirements. These factors make previous quiesce flow quite complicated, and hard to code and validate.

According to some embodiments, a shadow register allows hardware to perform the Quiesce operation and change the system configuration without executing any BIOS and/or SMI code under Quiesce. This allows for a fast change to the system configuration, low SMI latency (or no SMI latency), and removes the dependency on the processor cache architecture and associated complications.

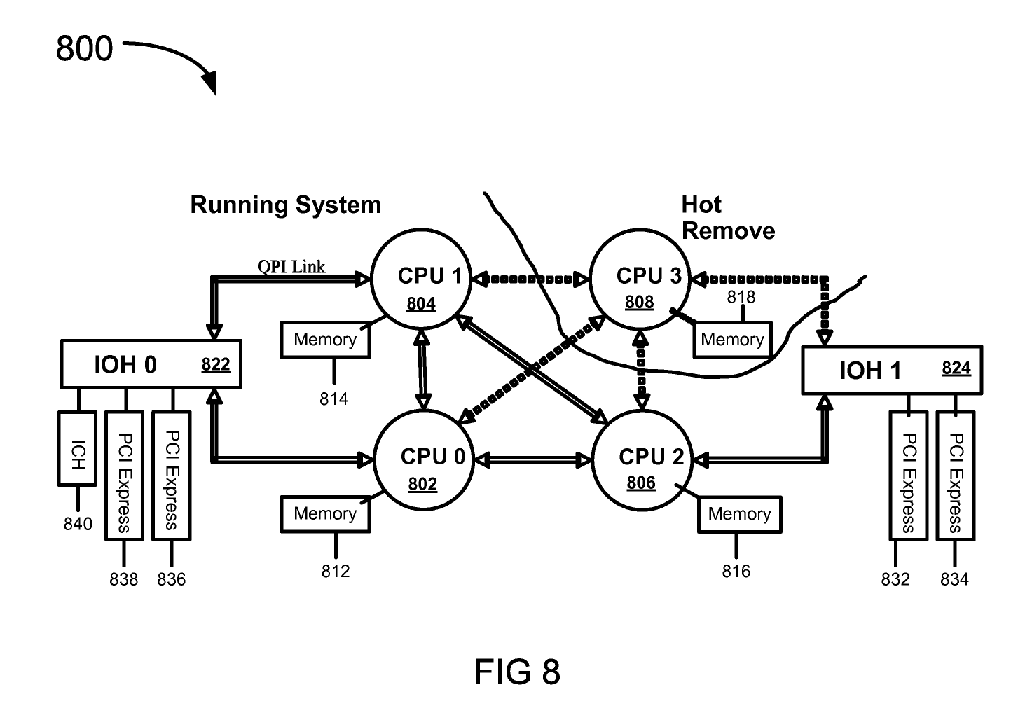

FIG. 8 illustrates a system 800 according to some embodiments. In some embodiments system 800 includes a plurality of processors and/or Central Processing Units (CPUs), including for example CPU0 802, CPU1 804, CPU2 806 and CPU3 808. In some embodiments system 800 additionally includes a plurality of memories, including for example, memory 812, memory 814, memory 816, and memory 818. In some embodiments, each of the processors 802, 804, 806, and 808 has a memory controller. In some embodiments system 800 additionally includes one or more Input/Output Hubs (IOHs), including for example IOH0 822 and IOH1 824. In some embodiments the processors 802, 804, 806 and 808 and the IOH 822 and IOH 824 are coupled together by a plurality of links and/or interconnects. In some embodiments, the links and/or interconnects coupling the processors 802, 804, 806 and 808 and the IOH0 822 and IOH1 824 are a plurality of coherent links, such as, for example, in some embodiments, Quick Path Interconnect (QPI) links and/or a plurality of Common System Interface (CSI) links.

The system 800 of FIG. 8 assumes that the CPU3 808 (and/or the CPU3 108 in the system of FIG. 1) was present when the system was booted, but is to be hot removed from the running system. The links (for example, coherent links and/or QPI links) between the other processors 802, 804 and 806 and the IOHs 822 and 824 are shown as initialized and operating links, but the links between the CPU3 808 and the other components are shown in FIG. 8 using dotted lines since those links need to no longer be active after the hot removal of CPU3 808. In order to handle the hot removal of CPU3 808, the OS will need to stop using the CPU3 808 and the memory 818 coupled to CPU3 808. The system must be quiesced, the CPU3 808 address routing in all sockets must be removed, and the link routing (for example, QPI routing) to CPU3 808 must be removed in all sockets. Then the system needs to be un-quiesced in order to continue the OS.

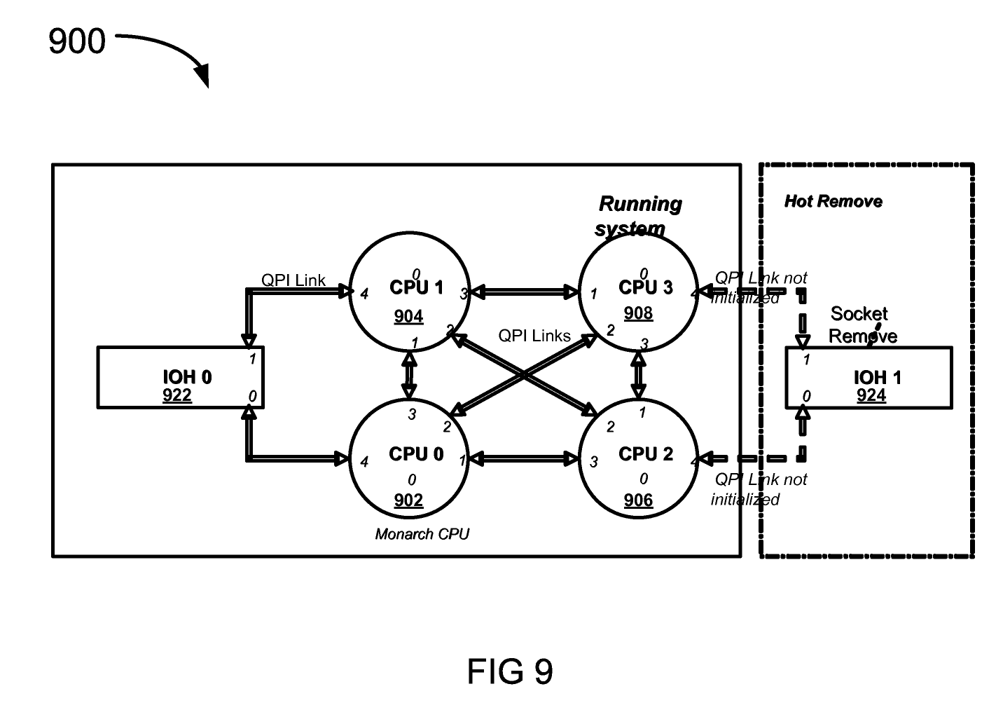

FIG. 9 illustrates a system 900 according to some embodiments. In some embodiments system 900 includes a plurality of processors and/or Central Processing Units (CPUs), including for example CPU0 902, CPU1 904, CPU2 906 and CPU3 908. In some embodiments system 900 additionally includes a plurality of memories, including for example, memory 912, memory 914, memory 916, and memory 918. In some embodiments, each of the processors 902, 904, 906, and 908 has a memory controller. In some embodiments system 900 additionally includes one or more Input/Output Hubs (IOHs), including for example IOH0 922 and IOH1 924. In some embodiments the processors 902, 904, 906 and 908 and the IOH 922 and IOH 924 are coupled together by a plurality of links and/or interconnects. In some embodiments, the links and/or interconnects coupling the processors 902, 904, 906 and 908 and the IOH0 922 and IOH1 924 are a plurality of coherent links, such as, for example, in some embodiments, Quick Path Interconnect (QPI) links and/or a plurality of Common System Interface (CSI) links.

The system 900 of FIG. 9 assumes that the IOH1 924 (and/or the IOH1 124 in the system of FIG. 1) was present when the system was booted, but is to be hot removed from the running system. The links (for example, coherent links and/or QPI links) between the processors 902, 904, 906, and 908, and the other IOH0 922 are shown as initialized and operating links, but the links between the IOH1 924 and the other components are shown in FIG. 9 using dotted lines since those links need to no longer be active after the hot removal of IOH1 924. In order to handle the hot removal of IOH1 924, the OS will need to stop using the IOH1 924. The system must be quiesced, the IOH1 924 address routing in all sockets must be removed, and the link routing (for example, QPI routing) to IOH1 924 must be removed in all sockets. Then the system needs to be un-quiesced in order to continue the OS.

In some embodiments, each agent (for example, each QPI agent) provides a set of shadow registers for the link routing (for example, QPI routing), the address decoder, the broadcast list, and any other register that would impact the system reconfiguration. In order to perform the configuration change, in some embodiments the shadow registers are programmed with software with the new configuration registers, and the software initiates the hardware request to perform the configuration switch. The new configuration takes effect as soon as the configuration switch is completed.

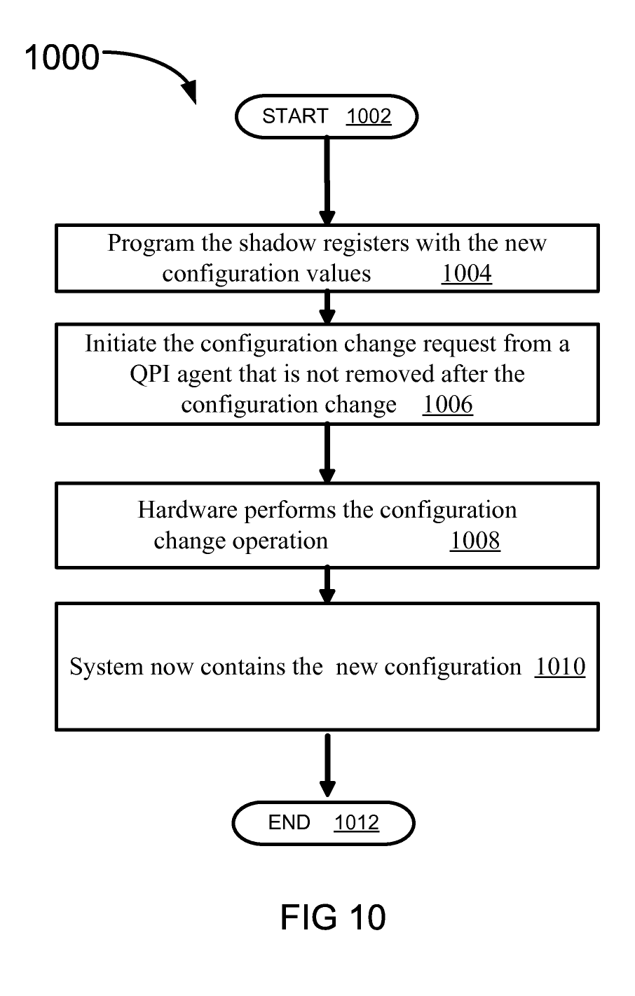

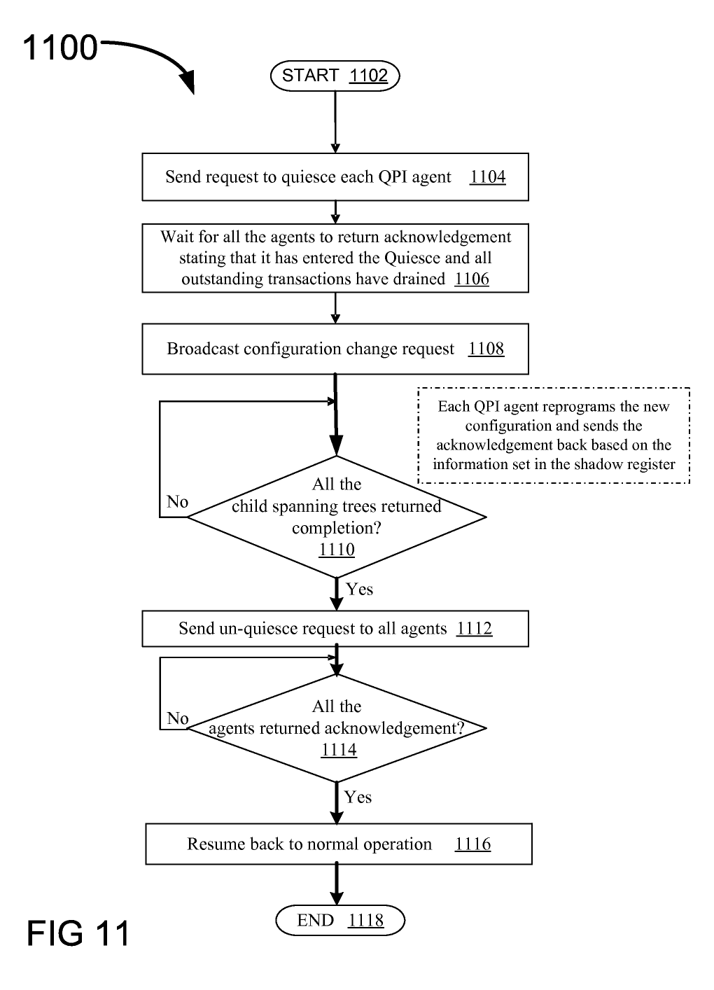

FIG. 10 illustrates a flow 1000 according to some embodiments. In some embodiments flow 1000 is a configuration change software flow. Flow 1000 starts at 1002. At 1004 the shadow registers are programmed with a new set of configuration values. At 1006 the configuration change request is initiated from an agent such as a QPI agent that is not removed after the configuration change. The configuration change is initiated by writing to a hardware register such as a Model Specific Register (MSR) or a Configuration Space Register (CSR). At 1008 the hardware performs the configuration change operation. In some embodiments, the hardware performs the configuration change operation at 1008, for example, in a manner similar to or the same as the flow 1100 illustrated in FIG. 11 and described in further detail below. The hardware performs the Quiesce and switches to the new configuration registers based on the shadow registers (for example, in some embodiments, as further illustrated in FIG. 11 and described below). At 1010 the system now contains the new configuration, and system operation can now continue with the new configuration. Flow 1000 ends at 1012.

FIG. 11 illustrates a flow 1100 according to some embodiments. In some embodiments, flow 1100 represents a hardware configuration change flow. Flow 1100 starts at 1102. A request is sent at 1104 to quiesce each QPI agent (or other type of agent in some embodiments). This blocks Direct Memory Access (DMA), and blocks any new transaction generation from any QPI agent other than the Quiesce initiating agent. In some embodiments, a poll is made for all outstanding transactions to have completed. At 1106 flow 1100 waits for all of the QPI agents to return an acknowledgement stating that the agent has entered the Quiesce, and all outstanding transactions have been drained. A request is made for all QPI agents to reprogram the register set (and/or the new configuration) from the shadow registers (and/or switch the register set to the shadow registers). An acknowledgement is sent back base on the information set in the shadow register, for example. In some embodiments, the register data contains who to respond to based on a spanning tree. Further information about how this occurs in some embodiments may be found, for example, in U.S. patent application Ser. No. 11/011,801, published as U.S. Patent Publication US-2006-0126656-A1 on Jun. 15, 2006 and entitled “Method, System, and Apparatus for System Level Initialization”.

At 1108 a configuration change request is broadcast. A determination is made at 1110 as to whether all of the child spanning trees have returned completion. In some embodiments, an acknowledgement is made that the system reconfiguration is complete. Once all the child spanning trees have returned completion at 1110, an Un-Quiesce request is sent to all QPI agents (and/or new agents) at 1112. At 1114 a determination is made as to whether all the agents (and/or new agents) returned acknowledgement. Once all the agents (and/or new agents) have returned acknowledgement at 1114 normal operation is resumed at 1116. This unblocks DMA and allows transactions to continue (for example, by returning to the execution code).

In some embodiments, shadow (and/or duplicate) registers hold the new configuration information. In some embodiments, initiation of the configuration change is implemented by software. In some embodiments, hardware performs a system quiesce and swiches the shadow configuration to a current configuration, and also performs an un-quiesce to then continue the system operation. In some embodiments, hardware performs checks to make sure all the QPI agents are in quiesce state before initiating the configuration register switch operation. In some embodiments, shadow registers containing a spanning tree are used to return data back after the reconfiguration.

Current server systems implement an MSR based mechanism to initiate Quiesce and UnQuiesce. The SMI code needs to bring all the processors to rendezvous and initiate the quiesce. The SMI needs to cache the code and data, and needs to make sure prefetch and speculative loads are prevented before it changes the system (processors do not provide direct control to disable speculative loads, so complex uncached and cached code setting sequences are required). Otherwise, memory access, snoops, prefetches and speculative loads would cause SMI code/data access issues during QPI route changes and result in system error. Validation of the SMI code and other settings involved in making the feature are very complex and may cause the SMI latency to exceed OS allowed time limits for SMI.

In some embodiments a shadow register set is used which can be computed and programmed outside the SMI and/or Quiesce/UnQuiesce time window. Additionally, the shadow register switch is done by the hardware rather than the complex software flow. This helps to reduce SMI latency.

Some embodiments do not depend on code and/or data caching behavior, and are therefore architecture independent.

In some embodiments, a scalable solution is provided since the shadow register switch occurs in hardware, and each of the QPI agents contains the shadow register set. Existing SMI based solutions require all the threads in SMI. As the number of QPI agents and/or cores increases, it takes a long time to complete the operation and the OS SMI latency requirement is violated. In some embodiments, a solution is more extensible from one generation to another and is scalable (for example, scalable across wayness).

In some embodiments, out-of-band (OOB) firmware (for example, such as the System Service Processor or SSP) is allowed to change the system configuration without exceeding the OS latency limit even when using slow sideband interface. The SSP cannot change the runtime system configuration when using previously existing solutions.

Current QPI solutions (which are key to support of RAS features on QPI platforms) are cache architecture dependent, are quite complex, and are hard to validate, and firmware handlers need to be hand tuned to fit within the OS latency requirements. Other alternatives such as running quiesce and reprogramming QPI routes and address decoders from direct connected flash are very slow and violate OS requirements for SMI latency. These problems are overcome according to some embodiments. In some embodiments, the programming of shadow registers is not done within the quiesce period, thus reducing the latency for quiesce as well as the complexity of the firmware performing the quiesce and system configuration change flow. According to some embodiments, dependencies on cache architecture are eliminated and the need for complex firmware flow is removed.

In some embodiments, a configuration change is performed by hardware, and no software intervention is required during the configuration change. In this manner, the total latency relating to changing the system configuration is much lower than existing solutions, and a real time response to the end user is enabled.

As described herein, support for high-end RAS features including but not limited to hot plug of processor, memory, onlining/offlining, etc. are key for platforms in the high-end server market segment. An effective QPI operation is required to implement these RAS flows. Current QPI quiesce flow for RAS is processor generation specific due to cache architecture dependencies, since the quiesce code has to run from cache without generating external memory accesses/snoops/speculative loads, etc. Such a flow is extremely complicated to code and hard to validate, and may therefore severely limit RAS support on QPI. In some embodiments, a simpler quiesce solution is used that is independent of processor cache architecture. Additionally, support for high-end RAS features is enabled on QPI platforms that scales well for larger multiprocessor (MP) platforms.

Some embodiments have been described herein as being applicable to System Management Interrupt (SMI) technology. However, other implementations relate to other runtime interfaces. For example, in some embodiments, a Platform Management Interrupt (PMI) is used.

Some embodiments have been described herein and illustrated as a socket that includes a processor core and/or integrated memory, for example. However, in some emobodiments further components are integrated into the socket. For example, in some embodiments, an I/O root complex is integrated in the processor socket, for example. In some embodiments, I/O devices are integrated in the processor socket. Further embodiments of additional components integrated into the processor socket are also apparent in current and future implementations of the embodiments.

Although some embodiments have been described herein as being applicable to QPI based systems, according to some embodiments these particular implementations may not be required. That is, embodiments described herein are applicable in some embodiments to any coherent link and are not limited to QPI. In some embodiments, non-QPI based systems are implemented. In some embodiments, node controller based systems are implemented.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method comprising:
caching system reconfiguration code and data to be used to perform a dynamic hardware reconfiguration of a system including a plurality of processor cores;
preventing any direct or indirect memory accesses during the dynamic hardware reconfiguration;
implementing the dynamic hardware reconfiguration by one of the processor cores or threads executing the cached system reconfiguration code and data.

2. The method of claim 1, further comprising allowing only one of the plurality of processor cores to run during the dynamic hardware reconfiguration.

3. The method of claim 1, further comprising blocking all of the plurality of processor cores other than the allowed one processor core from any outbound memory accesses.

4. The method of claim 1, further comprising disabling a prefetch to avoid memory accesses during the dynamic hardware reconfiguration.

5. The method of claim 1, further comprising avoiding speculative memory loads.

6. The method of claim 1, further comprising flushing one or more of the plurality of processor cores to make sure that all outstanding transactions are completed prior to performing the dynamic hardware reconfiguration.

7. The method of claim 1, further comprising avoiding any out of band debug hooks during the dynamic hardware reconfiguration.

8. The method of claim 1, further comprising selecting the one processor core out of the plurality of processor cores to perform the dynamic hardware reconfiguration.

9. The method of claim 1, wherein the dynamic hardware reconfiguration includes one or more of a hot add, a hot remove, a hot plug, a hot swap, a hot processor add, a hot processor remove, a hot memory add, a hot memory remove, a hot chipset add, a hot chipset remove, a hot Input/Output Hub add, a hot Input/Output Hub remove, a memory migration, a memory mirroring, runtime link reconfiguration, runtime error injection, and/or a processor migration.

10. The method of claim 1, wherein the dynamic hardware reconfiguration includes Reliability, Availability, and Serviceability features.

11. The method of claim 1, wherein the dynamic hardware reconfiguration is performed in a manner that is Operating System transparent.

12. The method of claim 1, wherein the dynamic hardware reconfiguration is an atomic updating of one or more hardware devices in the system.

13. The method of claim 1, wherein the dynamic hardware reconfiguration includes a quiesce operation.

14. The method of claim 1, further comprising programming shadow registers with a new set of configuration values.

15. The method of claim 1, further comprising initiating a configuration change by writing to a hardware register.

16. The method of claim 15, wherein the hardware register is a model specific register or a configuration space register.

17. The method of claim 1, further comprising performing a configuration change in response to a value in a hardware register.

18. An apparatus comprising:
a cache to store caching system reconfiguration code and data to be used to perform a dynamic hardware reconfiguration; and
a plurality of processor cores, wherein one of the processor cores is to execute the cached system reconfiguration code and data to perform the dynamic hardware reconfiguration, wherein direct or indirect memory access by the plurality of processor cores is prevented during the dynamic hardware reconfiguration.

19. The apparatus of claim 18, wherein only one of the plurality of processor cores is allowed to run during the dynamic hardware reconfiguration.

20. The apparatus of claim 18, wherein all of the plurality of processor cores other than the allowed one processor core are blocked from any outbound memory accesses.

21. The apparatus of claim 18, wherein a prefetch is disabled to avoid memory accesses during the dynamic hardware reconfiguration.

22. The apparatus of claim 18, wherein speculative memory loads are avoided.

23. The apparatus of claim 18, wherein one or more of the plurality of processor cores is flushed to make sure that all outstanding transactions are completed prior to performing the dynamic hardware reconfiguration.

24. The apparatus of claim 18, wherein any out of band debug hooks are avoided during the dynamic hardware reconfiguration.

25. The apparatus of claim 18, wherein the dynamic hardware reconfiguration includes one or more of a hot add, a hot remove, a hot plug, a hot swap, a hot processor add, a hot processor remove, a hot memory add, a hot memory remove, a hot chipset add, a hot chipset remove, a hot Input/Output Hub add, a hot Input/Output Hub remove, a memory migration, a memory mirroring, runtime link reconfiguration, runtime error injection, and/or a processor migration.

26. The apparatus of claim 18, wherein the dynamic hardware reconfiguration includes Reliability, Availability, and Serviceability features.

27. The apparatus of claim 18, wherein the dynamic hardware reconfiguration is performed in a manner that is Operating System transparent.

28. The apparatus of claim 18, wherein the dynamic hardware reconfiguration is an atomic updating of one or more hardware devices in the system.

29. The apparatus of claim 18, wherein the dynamic hardware reconfiguration includes a quiesce operation.

30. The apparatus of claim 18, further comprising shadow registers programmed with a new set of configuration values.

31. The apparatus of claim 18, at least one of the plurality of processor cores to initiate a configuration change by writing to a hardware register.

32. The apparatus of claim 31, wherein the hardware register is a model specific register or a configuration space register.

33. The apparatus of claim 18, further comprising a hardware register storing a value, wherein the one of the plurality of processor cores is to perform a configuration change in response to the value stored in the hardware register.
